(19) United States
(12) Patent Application Publication
(10) Pub. No.: US 2007/0106574 A1
(43) Pub. Date: May 10, 2007

(54) Inventory management system and method for a cellular communications system

(76) Inventors: Thomas A. Kappel, Naperville, IL (US); Ray K. Butler, Naperville, IL (US); Alexander Gordy, Highland Park, IL (US); Martin Coates, (US)

Correspondence Address: Eric D. Cohen, 22nd Floor, 120 South Riverside Plaza, Chicago, IL, 60606-3945, US

(21) Appl. No.: 11/269,273

(22) Filed: Nov. 8, 2005

(51) Int. Cl. G06Q 30/00

(52) U.S. Cl. 705/28

(57) ABSTRACT

A method and system for managing inventory in a cellular communications systems utilises wireless ID tag readers to monitor items of inventory. This enables all items of inventory at a cell site to be monitored and a central database periodically updated. In one embodiment GPS units at each site or associated with each ID tag may be used to monitor the position of the item of inventory. In another embodiment an item of inventory communicates its status to the ID tag which communicates this status information when read.

### FIELD OF THE INVENTION

This invention relates to an inventory management system and method suitable for a cellular telecommunications system. The method allows wireless reading of an identification tag of an item of inventory at a base station site, communicating information encoded in the identification tag along with physical location information to a central database, and automatically generating an entry for the item of inventory in an inventory management database.

### BACKGROUND OF THE INVENTION

Cellular communication systems consist of a multitude of items of inventory ranging from items of plant such as power supplies, air conditioning etc. to communications equipment such as amplifiers and antennas. It is desirable to have an accurate inventory of all equipment at a cell site at any point in time. This enables good inventory management and enables equipment failures to be well managed. Maintaining an accurate inventory database is labour-intensive and expensive as periodic visits and manual data entry are required to record all items of inventory.

U.S. Pat. No. 6,154,728 discloses an automated inventory management method and system for field replaceable cards of cellular communication systems. In this system the cards are assigned a unique address and a central site can read the address and status of each card. The system requires compatibility between the central site and the cards to enable them to be read. Allocation of addresses also needs to be managed. As cellular communication systems often consist of components from a variety of vendors it may be difficult to achieve such compatibility. Further, the system is only applicable to cards having addresses that can be read electronically and so inventory management for many assets must still be performed by manual inspection. This can only be done periodically and is expensive.

GB2298099 discloses a position or orientation determining system with primary application in direction finding systems. A first device including a GPS unit is placed near a second device and position information is transferred from the first device and is stored in the second device. The position information is not updated. In one embodiment identification information including the initial position information is sent to an “interrogator” on request. Where the “interrogator” is remote a powerful wireless radio is reqired, making each unit expensive. Where the interrogator is local the devices of a widely distributed system cannot be monitored. Further as the current physical location of an item is not monitored changes in physical position cannot be monitored.

It would be desirable to provide an automated inventory management method and system enabling all items of inventory to be automatically monitored.

It would also be desirable for such a system to provide an alarm should the status or location of an item of inventory change from that expected.

### SUMMARY OF THE INVENTION

According to one exemplary embodiment there is provided a method of managing inventory in a cellular communications network having inventory located at one or more base station sites, the method comprising:
i wirelessly reading an ID tag of an item of inventory at a base station site;
ii communicating information encoded in the ID tag along with physical location information to a central database; and
iii automatically generating an entry for the item of inventory in an inventory management database.

According to a further exemplary embodiment there is provided an inventory management system for a cellular communications system comprising:
a central database; and, at a base station:
a wireless ID tag reader; and
a controller linked to the central database via a communications link which receives data read by the wireless ID tag reader and communicates it to the central database.

According to a further exemplary embodiment there is provided a method of monitoring inventory in a cellular communications network comprising:
a. wirelessly monitoring inventory data of ID tags associated with items of inventory;
b. comparing received inventory data with prior inventory data; and
c. generating an alert signal when the inventory data for an ID tag changes.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 shows a schematic diagram of an inventory management system according to one embodiment;

FIG. 2 shows a schematic diagram of an inventory management system utilizing multiple wireless readers at each site;

FIG. 3 shows an RFID tag including a GPS chip;

FIG. 4 shows an RFID tag including a sensor input;

### DETAILED DESCRIPTION

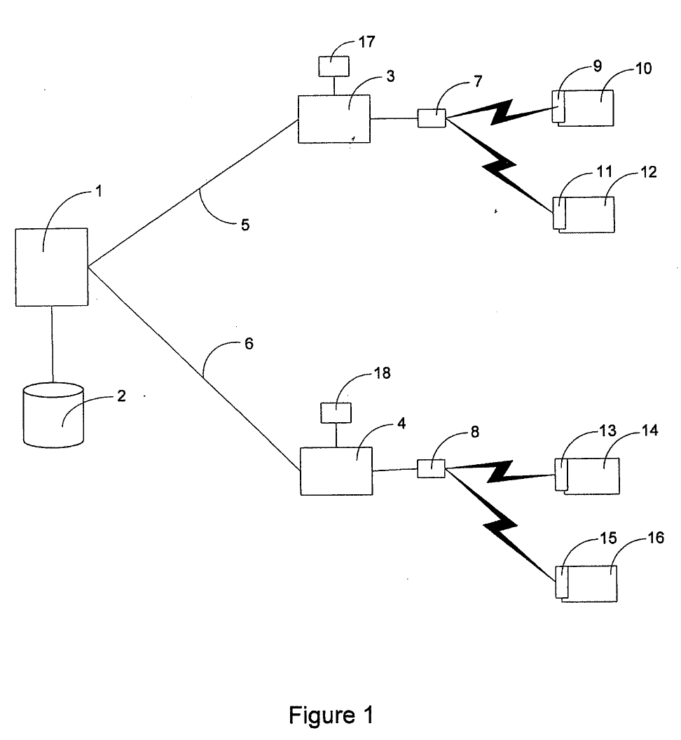

FIG. 1 shows an inventory management system according to one embodiment. A central controller 1 may communicate with an associated central database 2. Controllers 3 and 4 are located at different cell sites and may communicate with central controller 1 via backhaul links 5 and 6 (or some other suitable link). Controllers 3 and 4 are connected to associated wireless readers 7 and 8 which read ID tags 9, 11, 13 and 15 of associated inventory items 10, 12, 14 and 16. Optionally controllers 3 and 4 may have associated physical location units, such as GPS units 17 and 18.

The wireless readers 7 and 8 may be RFID tag readers, barcode readers (hand held or fixed) or even a camera. However, RFID tag readers are preferred as they do not require any particular orientation to be maintained between an ID tag and an RFID tag reader.

One or number of wireless readers 7, 8 may be employed at each cell site depending upon the technology employed and the type of inventory management required. In some applications inventory may simply be read as it enters and leaves via an access way. In other embodiments a number of wireless readers may be deployed about the cell site so that all items of inventory may be continuously monitored.

The ID tags 9, 11, 13 and 15 will include at least a unique inventory item identification number. They may further include information such as a device identification code, manufacturer code, model number, manufacture date, version code, firmware code, software code, service date, vendor code, warranty details or any other desired information. Such tags may be produced according to the format required by the telecommunication system operator to comply with the requirements of their database. The ID tags may be applied to any item of inventory by the manufacturer, supplier or installer. ID tags may be applied to any item of inventory including items of plant, such as power supplies, air conditioning equipment etc; communications equipment, such as amplifiers, antennas etc; or any other item at a cell site.

When an item of inventory 10 is introduced to a new cell site and is positioned so that wireless reader 7 can read ID tag 9, wireless reader 7 reads ID tag 9 and conveys the information stored on ID tag 9 to controller 3. Alternatively a hand held reader such as a hand held barcode reader, may read an ID tag after an item of inventory is installed or prior to removal. In one embodiment controller 3 may simply communicate the information read from ID tag 9 to central controller 1 via backhaul link 5 so that central database 2 may be updated with the information regarding the new item of inventory. Controller 3 may also send information identifying the cell site from which the information was sent or controller 1 may determine this and provide this information to central database 2.

Alternatively controller 3 may read its geographical location from a physical location system, such as a GPS unit 17 and combine this information with the information read from ID tag 9 and send this information to central controller 1 so that central database 2 may be updated with the information from ID tag 9 as well as the geographical location of the cell site at which inventory item 10 is located. Alternatively this information may be sent separately. This approach has the advantage that the controller 3 will always provide its correct geographical location and requires no configuration.

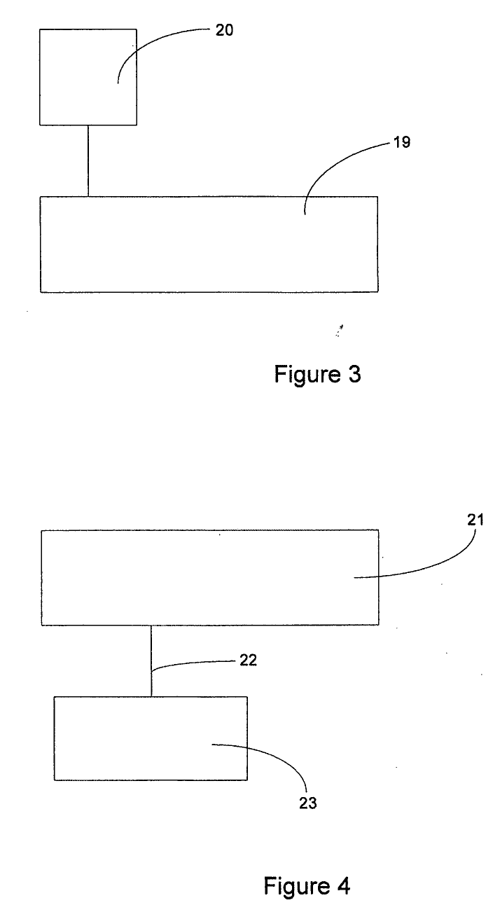

In an alternative embodiment shown in FIG. 3 RFID tag 19 may include a GPS chip 20 so that when a wireless reader reads an RFID tag it obtains the information stored in the RFID tag along with current geographical location information from the associated GPS chip 20. This enables the real time location of an item of inventory to be monitored over time. Alternatively the locations of the base station sites could be obtained from an updatable database that stores the current physical locations of sites of the network.

According to a further embodiment shown in FIG. 4 RFID tag 21 may include an input 22 from a monitoring circuit 23 of an associated item of inventory so that the status of the item of inventory may be monitored. For example, an electrical signal may be provided to an RFID tag should there be a change in the status of an item of inventory (e.g. a malfunction). Some RFID tags change the information stored by the RFID tag if a connection has broken. Upon breaking the connection the RFID take may change the information stored on the RFID tag to indicate the change in status. When the RFID tag is read this change in status can be detected and communicated to the central controller.

Database 2 may be populated with items yet to be installed at a site so that the system can monitor the installation of inventory at a site and identify any items of inventory yet to be installed.

The system described above may be operated in a variety of ways. Typically, as an item of inventory is introduced to a site its ID tag read by a wireless reader and this information is passed to the central controller with or without positional information as discussed above. Again this may be achieved using a hand held reader or by moving the item of inventory to a position where it can be read by the reader. The item of inventory is then automatically entered into the central database. This enables automated inventory updating at a cell site as items of inventory are introduced.

In a simple application a single reader may be placed at a point of access to a site. As items of inventory enter or leave via the access point the associated ID tag will be read and the central database updated.

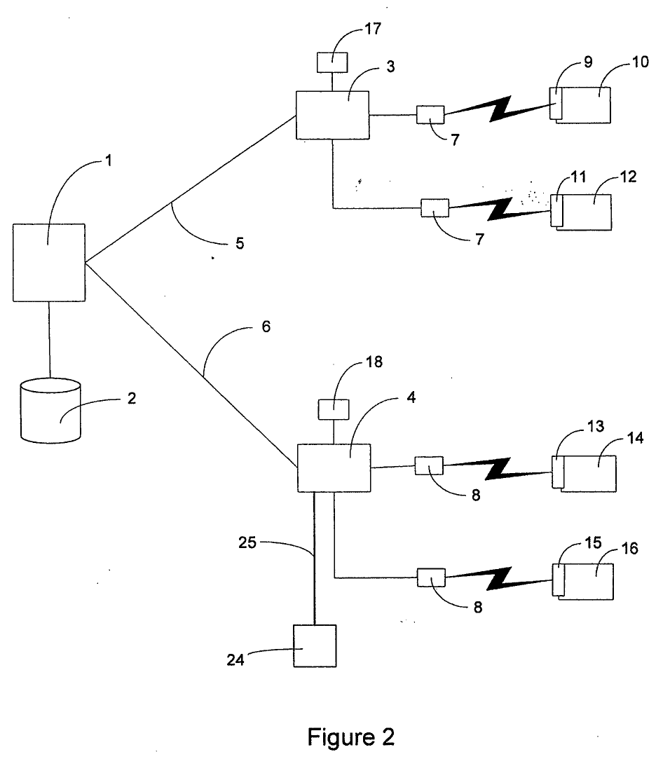

In a more sophisticated implementation as shown in FIG. 2 multiple wireless readers 7 and 8 capable of reading RFID tags for all items of inventory may be employed. In such a system all items of inventory may be continuously monitored. Items may be periodically monitored or at the request of the central controller with the current information communicated to the central database. Additionally items of inventory may be monitored electrically, such as item 24. Item 24 may be an antenna (as in the applicant's copending application 2004/0038714) or an electronic circuit such as a field replaceable card or the like capable of communicating its identification number to controller 4 via electrical signal path 25.

Where the ID tags include GPS chips the physical location of each item of inventory can be compared between each reading. A change in the physical location of an item of inventory can indicate the theft of an item or an operational problem, such as bird strike on an antenna. In such a case the central controller can alert the system operator to the problem when a change in physical location above a prescribed threshold is detected.

Where the ID tag receives status information from an item of inventory a change in the status of an item can be read by the wireless ID reader and communicated back to the central controller to alert the system operator. This provides a wireless status monitoring system integrated with the inventory management system.

The method and system of the invention allows any item of inventory in a widely distributed cellular system to be monitored. The system allows inventory entries to be automatically created and modified. The system provides detection of the absence of an item of inventory and monitoring of the status of equipment. The system is inexpensive and requires minimal human involvement.

While the present invention has been illustrated by the description of the embodiments thereof, and while the embodiments have been described in detail, it is not the intention to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the general inventive concept.

1. A method of managing inventory in a cellular communications network having inventory located at one or more base station sites, the method comprising:
i wirelessly reading an ID tag of an item of inventory at a base station site;
ii communicating information encoded in the ID tag along with physical location information to a central database; and
iii automatically generating an entry for the item of inventory in an inventory management database.

2. A method as claimed in claim 1 wherein the ID tags at a base station are read periodically and the information is conveyed to a central database.

3. A method as claimed in claim 2 wherein an alarm signal is generated if an ID tag is not identified as being present when the central database indicates that it should be present.

4. A method as claimed in claim 2 wherein an alarm signal is generated if information associated with an ID tag changes.

5. A method as claimed in claim 4 wherein an alarm signal is generated if the code of an ID tag changes.

6. A method as claimed in claim 4 wherein an alarm signal is generated if physical location information associated with an ID tag changes.

7. A method as claimed in claim 1 wherein an ID tag is read as an item of inventory is introduced to the base station.

8. A method as claimed in claim 1 wherein an ID tag is read as an item of inventory is removed from the base station.

9. A method as claimed in claim 1 wherein an ID tag is read at the request of the central database.

10. A method as claimed in claim 1 wherein the information is communicated to the central database via a backhaul link from the base station to the central database.

11. A method as claimed in claim 1 wherein the physical location information is obtained from a GPS receiver at the base station.

12. A method as claimed in claim 1 wherein current physical location information is obtained from a GPS receiver located on an item of inventory.

13. A method as claimed in claim 1 wherein the ID tag is an RFID tag.

14. A method as claimed in claim 1 wherein the item of inventory is an item of plant at the base station.

15. A method as claimed in claim 1 wherein the item of inventory is an item of communications equipment at the base station.

16. A method as claimed in claim 1 wherein the item of inventory is an antenna at the base station.

17. A method as claimed in claim 1 wherein The RF ID tag records information selected from: a device identification code, manufacturer code, model number, manufacture date, version code, firmware code, software code, service date, vendor code and warranty details.

18. An inventory management system for a cellular communications system comprising:
i a central database; and, at a base station:
ii a wireless ID tag reader; and
iii a controller linked to the central database via a communications link which receives data read by the wireless ID tag reader and communicates it to the central database.

19. A system as claimed in claim 18 wherein the controller communicates with the central database via a backhaul link.

20. A system as claimed in claim 18 wherein the controller includes a GPS receiver.

21. A system as claimed in claim 18 wherein the wireless ID tag reader is an RFID tag reader.

22. A system as claimed in claim 18 wherein the wireless ID tag reader is a barcode reader.

23. A system as claimed in claim 18 wherein the wireless ID tag reader is a camera.

24. A system as claimed in claim 18 including one or more item of inventory that has an electrically readable address connected to the controller by an electrical signal path.

25. A method of monitoring inventory in a cellular communications network comprising:
a. wirelessly monitoring inventory data of ID tags associated with items of inventory;
b. comparing received inventory data with prior inventory data; and
c. generating an alert signal when the inventory data for an ID tag changes.

26. A method as claimed in claim 25 wherein an alert signal is generated when the status of an ID tag changes from present to not present.

27. A method as claimed in claim 25 wherein an alert signal is generated when the status of an ID tag changes from an in use condition to a fault condition.

28. A method as claimed in claim 25 wherein an alert signal is generated when the status of an ID tag indicates a change in physical location.
